(19) United States
(12) Patent Application Publication
(10) Pub. No.: US 2006/0156357 A1
(43) Pub. Date: Jul. 13, 2006

(54) System and method for providing programming in a multi-dwelling unit or multi-tenant unit network

(76) Inventors: Terry Wayne Lockridge, Indianapolis, IN (US); Tim Evan Marks, Carmel, IN (US); Mike Arthur Derrenberger, Fishers, IN (US)

Correspondence Address: THOMSON LICENSING INC., PATENT OPERATIONS, PO BOX 5312, PRINCETON, NJ, 08543-5312, US

(21) Appl. No.: 10/526,536

(22) PCT Filed: Sep. 5, 2003
(86) PCT No.: PCT/US03/27893

§ 371 Date: Mar. 2, 2005

Related U.S. Application Data
(60) Provisional application No. 60/408,452, filed on Sep. 5, 2002.
(60) Provisional application No. 60/408,391, filed on Sep. 5, 2002.
(60) Provisional application No. 60/408,546, filed on Sep. 5, 2002.
(60) Provisional application No. 60/408,451, filed on Sep. 5, 2002.

(51) Int. Cl. H04N 7/173

(52) U.S. Cl. 725/90; 725/88; 725/102; 725/134

(57) ABSTRACT

A system and method for providing programming to a client in a Multi-Dwelling Unit or Multi-Tenant unit network. The system and method includes various embodiments for converting pay per view content to video on demand content, collecting and displaying popular programs to a client, and billing a client for the utilization of personal video recording functions.

### FIELD OF THE INVENTION

The present invention relates to providing video services in a Multi-Dwelling or Multi-Tenant network.

### BACKGROUND OF THE INVENTION

In conventional pay per view (“PPV”) systems, clients may order a PPV program and view the program at a scheduled broadcast date and time. However, one drawback in using conventional PPV systems is that a viewer is forced to continuously view the broadcast program from start to finish. As a result, if the viewer attention is unexpectedly drawn away the viewer will miss at least some of the broadcast program. Another drawback encountered in both conventional PPV and broadcast systems is that a viewer is often given little real time guidance about the popularity of the PPV and broadcast programming being offered. The present invention is directed towards overcoming these drawbacks.

### SUMMARY OF THE INVENTION

A system and method for providing programming to a client in a Multi-Dwelling Unit or Multi-Tenant unit network. The system and method includes various embodiments for converting pay per view (PPV) content to video on demand (VOD) content, collecting and displaying popular programs to a client, and billing a client for the utilization of personal video recording (“PVR”) functions.

### BRIEF DESCRIPTION OF THE DRAWINGS

In the drawings:

FIG. 1 is an exemplary system diagram of the present invention; and

FIG. 2 is a flowchart illustrating a PPV to VOD conversion process of the present invention;

FIG. 3 is a flowchart illustrating another PPV to VOD conversion process of the present invention;

FIG. 4 is a flowchart illustrating a process of collecting and displaying popular programs to a client in accordance with the present invention; and

FIG. 5 is a flowchart an exemplary billing process of the present invention.

The characteristics and advantages of the present invention will become more apparent from the following description, given by way of example.

### DETAILED DESCRIPTION OF THE PREFERRED EMBODIMENT

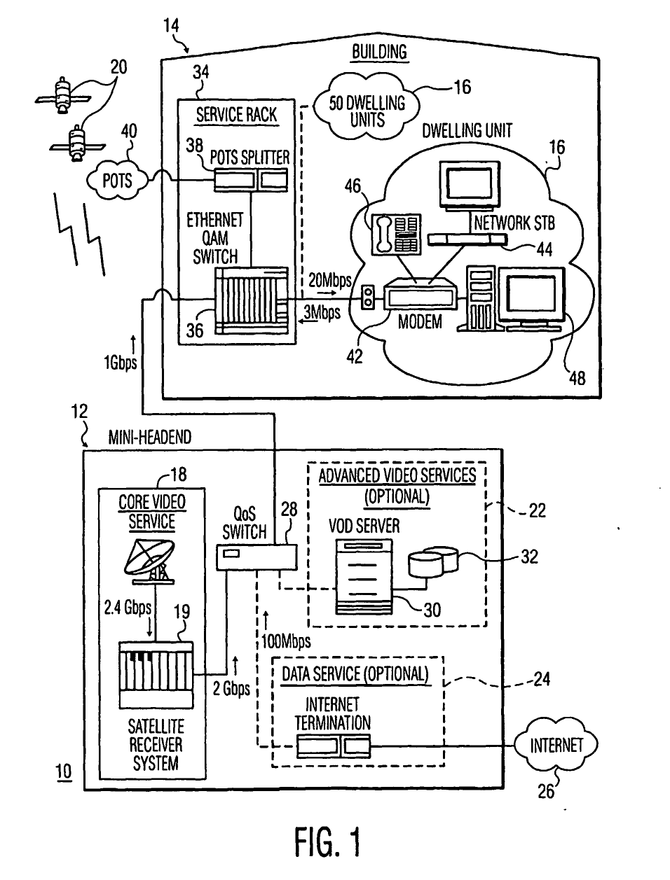

Referring now to FIG. 1, an exemplary system 10 that operates according to the principles of the present invention is shown. System 10 is an integrated digital data system to provide broadband, digital video, and services to multiple users. More specifically, system 10 integrates quality audio and video with digital IP data services for multiple users. This system design provides a platform to launch a variety of cost effective digital services. System 10 is designed to be scalable, so different digital data services can be added incrementally.

System 10 includes a Mini-Headend Unit 12 where digital audio, video, and data services are received, aggregated together and distributed, and a Multi-Dwelling Unit and/or Multi-Tenant Unit (“MxU”) network 14. Network 14 may be located in one or more apartment buildings, hotels, or any other structure where multiple clients desiring digital audio, video, and data services reside.

Mini-Headend Unit 12 is responsible for receiving data, providing Quality of Service (“QoS”), providing customized services, and routing data to dwelling units 16 in the MxU network 14. Mini-Headend unit 12 includes a Core Video Service System 18, an Advanced Video Services System 22, a Data Service System 24 communicatively connected to the Internet 26, and a QoS switch 28.

Core Video Service System 18 preferably includes a Satellite Receiver System 19 communicatively connected to satellites 20. Satellite Receiver System 19 is able to scale the number of streams received from satellites 20 in accordance with the number of clients desiring service. More specifically, Satellite Receiver system 18 runs a multi-cast server to allow network set top boxes 44 in the dwelling units 16 to request digital data streams. Satellite Receiver system 18 scales by the number of tuning blades in the chassis until all transponders for the satellite are being received. A fully loaded chassis having 60 transponders is able to handle an input data rate of 2.4 Gbps. At this point, the chassis is able to handle n users by accepting a new user request to the appropriate multi-cast group. Satellite Receiver System 19 is able to receive satellite signals and output IP packets at a data rate of 2 Gbps to multi-cast aware switch 28. More specifically, the IP packets that are sent out use QoS (as set forth in standards IEEE 802.lp (entitled “Traffic Class Expediting and Dynamic Multicast Filtering”) and IEEE 802.1q (entitled “Virtual LANs”)) to insure that the packets are delivered promptly. The network interface on the Satellite Receiver System 19 is a 1 Gbps Ethernet port and is expandable to two 1 Gbps Ethernet ports. A management system of the Satellite Receiver 19 accepts requests for programs from clients. The management system allows clients to select a satellite, transponder, and program IDs, and allows the Satellite Receiver System 19 to provide specific program streams to the client. The management system also supports multi-casting to save bandwidth. Although satellite receiver system 19 and satellites 20 are illustrated as the content delivery medium in FIG. 1, the use of other media (e.g., cable, fiber, etc.) for delivering content is considered within the scope of the invention.

Advanced Video Services system 22 is a platform that works in conjunction with the Satellite Receiver 19 to enable additional digital video services. Advance Video Services system 22 is scaled according to the number of clients using the service. For example, system 22 may require more servers 30 as the number of clients increases. The types of services provided are, inter alia, Video On Demand, Near Video On Demand, Limited Video On Demand, Nielsen Ratings, Time Shift, Auto Record, Personal Video Recording (“PVR”), and the like. Advanced Video System 22 includes a Conditional Access System (not shown) that is used for program streams that are recorded to hard drive(s) 32. When recording, the original program stream received from Satellite Receiver System 19 is decrypted, picture data is extracted, and a new program stream (containing the extracted picture data) is encrypted and stored onto hard drive(s) 32. The network provider's conditional access system is terminated at the Advanced Video System Server 30 and the new conditional access system is used thereafter.

Data Service System 24 is scaled according to the number of clients using internet service and the required speed or bandwidth of the internet service.

Mini-Headend unit 12 may include a Gigabit QoS Ethernet switch 28 (necessary for medium to large systems) that is scalable and can be removed in small installations. As known by those skilled in the art, some of the issues that are considered when selecting switch 28 are the type of services provided and how many dwelling units 16 in MxU network 14 need to be supported. Switch 28 provides connectivity between Satellite Receiver System 19, Advance Video Services system 22 and Data Services System 24. Switch 28 also provides connectivity from the Mini-Headend unit 12 to the MxU network 14. Switch 28 supports full-duplex Gigabit Ethernet interfaces and is scalable to support systems of various sizes. Switch 28 supports the QoS set forth in the IEEE 802.1p and 802.1q standards. Having QoS facilitates the communication between switch 28 and Advanced Video Services System 22 and Data Services System 24. More specifically, video data from Video Services system 18 and Advanced Video Services system 22 is given a higher priority than data from Data Service system 24. For example, when video data and internet data is simultaneously requested, video data is transmitted first and the internet data is either transmitted simultaneously if enough bandwidth is available or transmitted at a later time when sufficient bandwidth becomes available.

MxU network 14 includes a service rack 34 and dwelling units 16. Service rack 34 is scalable according to the number of dwelling units 16 in the MxU network 14 and is located in the central point where the phone lines in the MxU network 14 come together. The number of MxU networks 14 in system 10 dictates the number of service racks 34 required. Preferably, a service rack 34 is provided for each network 14 (e.g., building) in a multi-network environment (e.g., a multiple building complex). Each service rack 34 includes a VDSL switch 36 that uses a Plain Old Telephone Service (“POTS”) Splitter 38 to combine POTS service 40 with the digital video, audio, and data received from the QoS switch 28 of Mini-Headend 12 via a 1 Gbps phone line. Although VDSL switch 36 is illustrated as being an Ethernet QAM switch, it should be noted that the use of any other Ethernet switch is considered within the scope of the present invention.

In system 10 each Dwelling Unit 16 that has subscribed to digital services is required to have a consumer premises equipment (“CPE”) device. The CPE device for a given dwelling unit 16, depending on the client's service subscription, may include a modem 42, a network set top box (“STB”) 44, both a modem 42 and a STB 44, or an integrated modem and STB unit (not shown). The exemplary system 10 of the present invention requires at least the modem 42 for the reception of digital data, audio, and video services. Modem 42 is connectable to switch 36 via phone lines and terminates the VDSL line. Modem 42 also has a POTS Splitter (not shown) and a connection for phone services 46. Modem 42 has an Ethernet port to provide computers 48 internet access and network STBs 44 access to audio and video services.

Although phone lines are shown as being used as the communication medium between the dwelling units 16 and the Mini-Headend unit 12, cable and wireless networks are considered within the scope of the invention.

In summary, system 10 provides the architecture to deliver, inter alia, digital audio, digital video, high-speed Internet access, telephony services, security services, and the like to a client residing at a dwelling unit 16, and provides a revenue stream and a platform to add incremental or new services to the system provider.

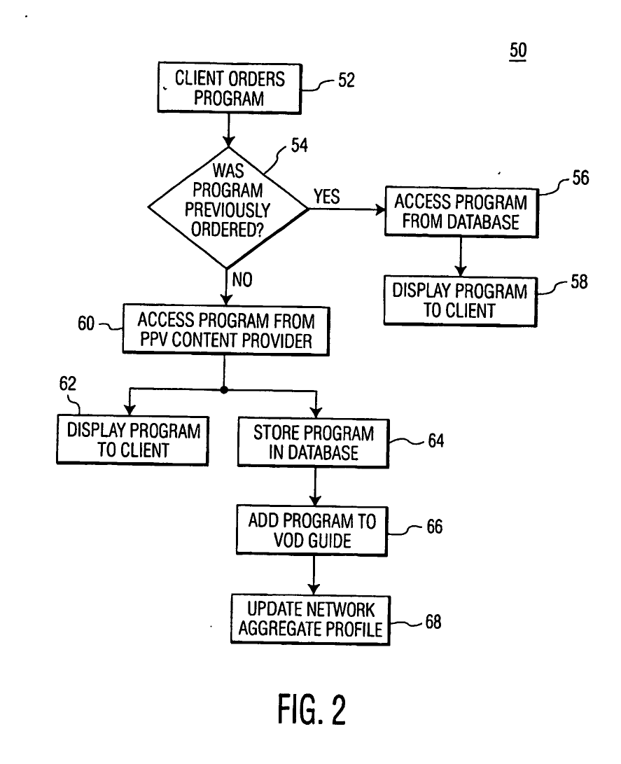

Referring Now to FIG. 2, a process 50 for converting pay per view (“PPV”) content to video on demand (“VOD”) is shown. Initially, at step 52, a client at one of the dwelling units 16 orders a PPV program by selecting the program from a PPV page of a program guide displayed by STB 44. STB 44 transmits the request to Mini-Headend Unit 12. Mini-Headend Unit 12, at step 54, queries the VOD Server 30 to determine whether the requested program was previously ordered and stored in a hard drive 32 of the Advanced Video Services system 22. If so, at step 56, Mini-Headend Unit 12 instructs VOD server 30 to retrieve the stored program from the hard drive 32 and transmit the program to the requesting STB 44 via switches 28 and 36. Afterwards, at step 58, STB 44 displays the stored program to the client.

If the requested program was not previously ordered and stored, Mini-Headend unit 12, at step 60, instructs Satellite Receiver System 19 to access and download the requested PPV program from the satellite service provider and instructs VOD server 30 to store the PPV program in the hard drive 32. Afterwards, while the PPV program is being sent from Satellite Receiver System 19 to STB 44, via switches 28 and 36, so the client, at step 62, can view the program, the program, at step 64, is simultaneously stored by VOD server 30 on the hard drive 32. After VOD server 30 stores the program, Mini-Headend unit 12, at step 66, adds the title of the program to a VOD page of the program guide (accessible by the client via the STB 44) and, at step 68, updates the network aggregate profile (discussed in further detail below).

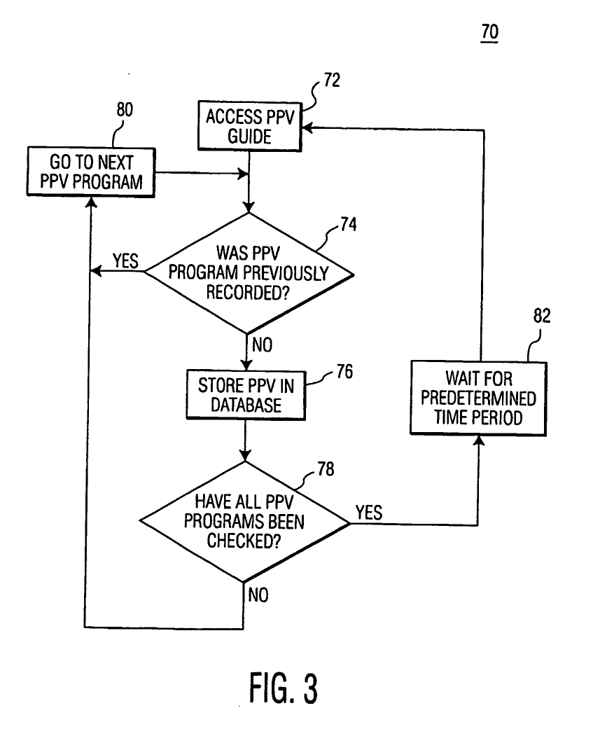

Referring now to FIG. 3, an alternative process 70 for converting PPV content to VOD content is shown. Periodically, at step 72, Mini-Headend unit 12 accesses the PPV page of the program guide provided by the Core Video Service provider via Satellite Receiver system 19. Afterwards, at step 74, Mini-Headend unit 12 determines if the first listed PPV program was previously recorded by the VOD server 30. If so, Mini-Headend unit 12, at step 80, checks the next PPV program listed in the PPV page. If not, Mini-Headend unit 12, at step 76, instructs Satellite Receiver system 19 to download the PPV program and VOD server 30 to store the downloaded program on a local database (e.g., Hard Drives 32). After the program is stored by VOD server 30, Mini-Headend unit 12 adds the title of the program to a VOD page of the program guide and updates the network aggregate profile. Next, at step 78, Mini-Headend unit 12 determines if all the PPV programs listed on the PPV page have been checked. If so, Mini-Headend unit 12, at step 82, waits a predetermined time period (programmable by the system operator) before returning to step 72 and accessing the PPV page of the program guide. If not, Mini-Headend unit 12, at step 80, checks the next PPV program listed in the PPV page.

It should be noted that under conversion processes 50 or 70, clients can view a program while it is being stored on hard drives 32. This Near Video On Demand (“NVOD”) feature permits the system provider to quickly alter (e.g., change or broaden) the program mix offered under the VOD model. It should also be noted that Mini-Headend unit 12 may release programs from storage on hard drives 32 on a first-in first-out (“FIFO”) basis. Alternatively, Mini-Headend unit 12 may release programs from storage based on the frequency of viewing by clients over time. Under this approach, programs that are not reviewed by a predetermined number of clients within a predetermined time period are released from storage. The amount of unique stored programming available under the VOD model is related to the size of the storage devices 32, the length of time system 10 has been operational, and the amount of unique PPV content being provided by the core video service provider. Clients may also be permitted to lengthen the time that a program is stored for a fee.

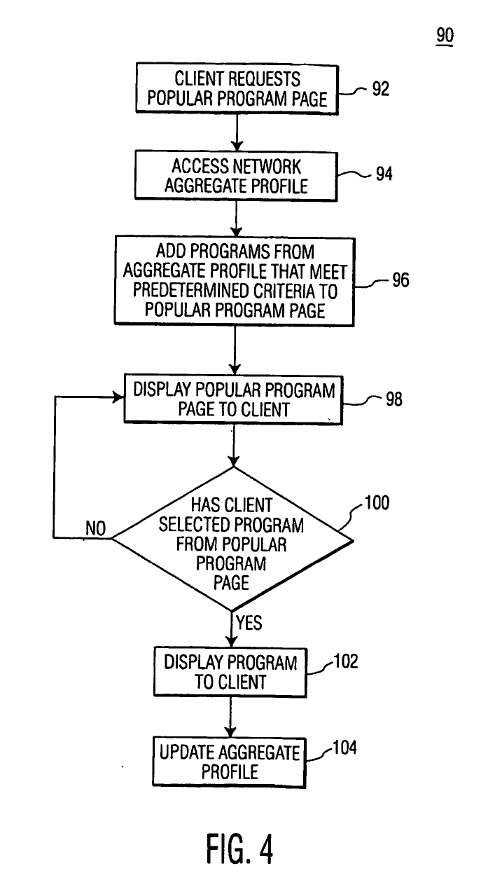

Referring now to FIG. 4, a process 90 for collecting and displaying popular programs to a client is shown. Initially, at step 92, the client requests the display of the popular program page of the program guide via STB 44. STB 44 passes the request to Mini-Headend Unit 12 via switch 36. In response to the request Mini-Headend unit 12, at step 94, accesses the network aggregate profile containing a listing of the number of times distinct programs (still stored in the hard drives 32 of the Advanced Video Services System 22) have been ordered and/or viewed by network clients. Next, at step 96, Mini-Headend Unit 12 adds programs meeting a predetermined criteria to a popular program page of the program guide passes the popular program page to STB 44 via switch 36. It should be noted that there are many types of predetermined criteria, as known by those skilled in the art. For example, the predetermined criteria may include programs that were ordered/viewed at least X amount of times, the top 10, 20, or 30 programs, a certain class of programs (e.g., sports), or programs in a certain high usage time slot. Further more, the predetermined criteria may be provided from a broker based on a fee (e.g., all CBS programming during primetime). STB 44 then displays, at step 98, the popular program page to the client. Afterwards, STB 44, at step 100, determines whether the client has selected a program from the popular program page. If not, STB 44 returns to step 98 and continues to display the popular program page until the client selects a program, navigates to another portion of the program guide, or closes the program guide. If so, STB 44, at step 102, retrieves the stored program from Mini-Headend unit 12 and displays the program to the client. Afterwards, at step 104, Mini-Headend Unit 12 updates the aggregate profile to account for the ordered program.

The aggregate profile (and related popular program page) may be maintained for the entire system 10, each multi-dwelling unit 14, or for special groups (e.g., Sci-Fi fans, etc. . . . ).

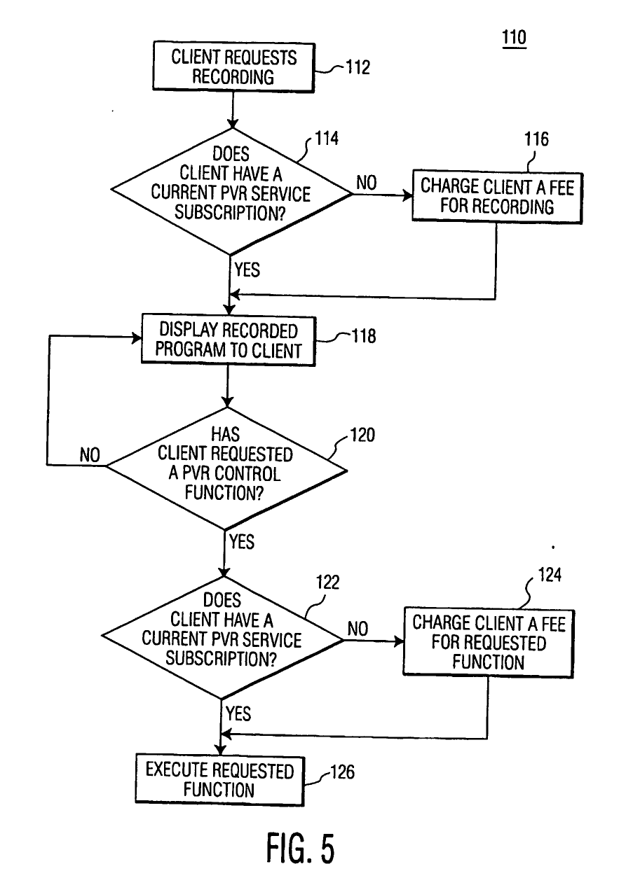

Referring now to FIG. 5, an exemplary billing process 110 for a Personal Video Recording (“PVR”) service provided by the Advanced Video Services system 22 of Mini-Headend unit 12 is shown. When a client, at step 112, request a recording via STB 44, Mini-Headend Unit 12, at step 114, determines whether the client has a current PVR service subscription. If not, Mini-Headend unit 12, at step 116, charges a predetermined fee to the client's account for recording the program. If the client has a current subscription the client is not charged an additional recording fee. At the client's request, Mini-Headend unit 12 will retrieve the recorded program from hard drive 32, pass the retrieved program to the client's STB 44 for display, at step 118, to the client. During the display of the recorded program, STB 44, at step 120, will monitor request from the client to determine if the client is requesting a PVR control function (e.g., rewind, pause, fast forward, etc. . . . ). STB 44 passes any PVR control requests received from the client to Mini-Headend unit 12. Mini-Headend unit 12 then, at step 122, determines whether the client has a current PVR service subscription. If not, Mini-Headend unit 12, at step 124, charges a predetermined fee to the client's account for the PVR control request and, at step 126, executes the requested function. If the client has a current PVR service subscription the client is not charged for PVR control requests. Mini-Headend Unit 12 maintains a log of client requests (including, inter alia, client ID, request, and time of request) to be used by a billing system (not shown) to create client invoices. Many types of billing systems may be used in conjunction with system 10, as known by those skilled in the art.

It should be noted that a client may order a program from the popular program page (see FIG. 4) for free, or for a fee based on a per program or monthly basis.

Although the present invention has been described in conjunction with the embodiments disclosed herein, it should be understood that the foregoing description is intended to illustrate and not limit the scope of the invention as defined by the claims.

1. A method for providing a program to a client, the method comprising the steps of:
receiving a request for a pay per view (PPV) program from the client;
determining if the requested program already resides on a local storage device;
retrieving the requested program from the local storage device if the requested program resides thereon;
transmitting the retrieved program to the client for display;
downloading the requested program from a PPV service provider if the requested program does not reside on the local storage device; and
transmitting the downloaded program to the client for display and to the storage device for storage.

2. The method of claim 1, further including the steps of:
periodically accessing a PPV page provided by the PPV service provider;
determining if a program listed on the PPV page is stored in the local storage device;
downloading the program if it is not stored in the local storage device; and
transmitting the downloaded program to the storage device for storage thereon.

3. The method of claim 2, further including the step of:
updating a video on demand page in a program guide so the page lists the title of the downloaded program.

4. The method of claim 1, further including the step of:
updating a video on demand page in a program guide so the page lists the title of the downloaded program.

5. The method of claim 1, further including the step of:
updating a network aggregate profile to reflect the client's request for the stored or downloaded program.

6. The method of claim 5, further including the steps of:
selecting programs in the network aggregate profile that meet a predetermined criteria; and
generating popular program page in a program guide, the popular program page listing the selected programs.

7. The method of claim 6 wherein the predetermined criteria is if the number of times a program has been requested exceeds a predetermined threshold.

8. The method of claim 1, further comprising the steps of:
offering personal video recording services to a client for programs stored in the local storage device; and
charging the client a fee for each PVR service requested.

9. The method of claim 8, wherein the PVR services offered are at least one of pause, rewind, fast forward and random access.

10. A system for providing a program to a client, the system comprising:
means for receiving a request for a pay per view (PPV) program from the client;
means for determining if the requested program already resides on a local storage device;
means for retrieving the requested program from the local storage device if the requested program resides thereon;
means for transmitting the retrieved program to the client for display;
means for downloading the requested program from a PPV service provider if the requested program does not reside on the local storage device; and
means for transmitting the downloaded program to the client for display and to the storage device for storage.

11. The system of claim 10, further comprising:
means for periodically accessing a PPV page provided by the PPV service provider;
means for determining if a program listed on the PPV page is stored in the local storage device;
means for downloading the program if it is not stored in the local storage device; and
means for transmitting the downloaded program to the storage device for storage thereon.

12. The system of claim 11, further comprising:
means for updating a video on demand (VOD) page in a program guide so the page lists the title of the downloaded program.

13. The system of claim 10, further comprising:
means for updating a video on demand page in a program guide so the page lists the title of the downloaded program.

14. The system of claim 10, further comprising:
means for updating a network aggregate profile to reflect the client's request for the stored or downloaded program.

15. The system of claim 14, further comprising:
means for selecting programs in the network aggregate profile that meet a predetermined criteria; and
means for generating a popular program page in a program guide, the popular program page listing the selected programs.

16. The system of claim 15 wherein the predetermined criteria is if the number of times a program has been requested exceeds a predetermined threshold.

17. The system of claim 10, further comprising:
means for offering personal video recording services to a client for programs stored in the local storage device; and
means for charging the client a fee for each PVR service requested.

18. The system of claim 17, wherein the PVR services offered are at least one of pause, rewind, fast forward and random access.
